(19) United States
(12) Patent Application Publication
(10) Pub. No.: US 2006/0143600 A1
(43) Pub. Date: Jun. 29, 2006

(54) Secure firmware update

(76) Inventors: Andrew Cottrell, San Jose, CA (US); Jithendra Bethur, Newark, CA (US); Timothy J. Markey, San Jose, CA (US); M. Srikant, San Jose, CA (US); Lakshmanan Srinivasan, San Jose, CA (US)

Correspondence Address: PHOENIX TECHNOLOGIES LTD., 915 MURPHY RANCH ROAD, MILPITAS, CA, 95035, US

(21) Appl. No.: 11/026,813

(22) Filed: Dec. 29, 2004

(51) Int. Cl. G06F 9/44

(52) U.S. Cl. 717/168

(57) ABSTRACT

A secure firmware update method includes receiving a firmware update image, for example, firmware code including corrected or updated functionality. Next, the firmware update image and the source of the firmware update image are authenticated. After the firmware update image and the source of the firmware update image have been authenticated, the current firmware image is replaced by the firmware update image. If either of the new firmware image or the firmware update module is not authorized, the memory remains locked; thereby, preventing the unauthorized firmware image from being flashed into the memory. An electronic device includes a processor and a memory. The memory maintains instructions that when executed by the processor, causes the processor to receive a firmware update image. Next, the instructions cause the processor to authenticate the firmware update image and the source of the image. After the firmware update image and the source of the firmware update image have been authenticated, the current firmware image is replaced by the firmware update image.

### FIELD OF THE INVENTION

The present invention generally relates to electronic devices and, more particularly, to securely updating firmware that executes on electronic devices.

### BACKGROUND OF THE INVENTION

Electronic devices, for example, laptop computers, desktop computers, personal digital assistants (PDA's), Internet appliances, embedded devices, for example, routers and set-top boxes, wireless communication devices and other similar devices and combinations thereof typically include a controller (e.g. central processing unit) and a non-volatile or read only memory (ROM) which contains firmware or other suitable code that is executed by the controller. When the electronic device is initially powered up, a special ROM based program, for example, Basic Input/Output System (BIOS) code is handed control of the electronic device by the controller.

The BIOS is responsible for initializing and configuring the various hardware subsystems, for example, display controller, Input/Output (I/O) controller or other suitable component or series of components present within or controlled by the electronic device, and initiates the operating system (OS) boot process. These initialization and booting tasks are typically referred to as the Power on Self Test (POST). Currently, modern personal computer (PC) systems use a flash memory; thereby, allowing the BIOS to be updated.

Occasionally, original equipment manufacturers (OEM's) or original device manufacturers (ODM's) issue updates to correct various problems or add enhancements to the BIOS. The updates are provided as corrected images of the pervious version of the BIOS, or the version of the BIOS that is being either corrected or enhanced. During an update, the new BIOS image replaces the original BIOS image, for example, through a flash update process. In order for the BIOS to be updateable, the flash memory that stores the BIOS image must be maintained in an unlocked state after the electronic device (e.g. personal computer) has booted the operating system. Since the flash memory, or other suitable memory, is not locked, it can be modified by any process that has access to the memory. Because the flash memory is updateable, it is also vulnerable to malicious or other unwanted attack.

For example, an attacker (e.g. a individual or a third party program) could insert (via a flash update process) unauthorized firmware into the flash memory that mimics the functionality of the replaced BIOS as well as perform unauthorized actions, for example, spy on the users key strokes or download additional and unauthorized programs from the Internet. Such firmware would essentially be immune from detection by existing virus detection programs due to the unsecure nature of the flash update process.

Conventional methods to prevent such an attack include providing electronic devices with flash memories that support lockable memory ranges which, once locked, cannot be unlocked until the device power has been cycled. Power cycling typically occurs when the electronic device is in a cold boot process. A drawback associated with using the cold boot process to control the locking of the applicable memory is that the cold boot process takes a relatively long period of time (e.g. upwards of three minutes) to complete; thereby, causing user frustration.

### SUMMARY OF THE INVENTION

A secure firmware update method includes receiving a firmware update image, for example, firmware code including corrected or updated functionality. Next, the firmware update image and the source of the firmware update image are authenticated. In an exemplary embodiment, a device operating according to the present invention includes a locked memory. A firmware application module is provided within the basic input output system or other core system software (CSS) of the corresponding device to call an authorized firmware update module that authenticates the new or updated firmware image and the source of the firmware update image. The memory in unlocked and the authentication status of the firmware update image and the source of the firmware update image is performed. After the firmware update image and the source of the firmware update image have been authenticated, the current firmware image is replaced by the firmware update image, for example, by reflashing the memory. The memory unlocking is performed during an S3 resume mode. If either of the new firmware update image or the source of the firmware update image is not authorized, the memory remains locked; thereby, preventing the unauthorized firmware image from being flashed into the memory.

The S3 resume mode refers to a change in device power management state, for example, from the S3 state to the S0 state. The S3 state, referred to as standby, is an intermediate power saving state in which some of the components of the device, for example, the central processing unit power down to save energy. The S0 state refers to the normal full power state of the device. When the device is in the S3 state, the contents of the system memory are preserved in order to allow the device to quickly enter the S0 state. By implementing the flash or memory update during the S3 state, the security and authentication of the update is assured, along with avoiding the latency that accompanies conventional cold boot processes.

An electronic device includes a processor and a memory that is coupled to the processor. The memory includes instructions that when executed by the processor, causes the processor to receive a firmware update image, for example, a new firmware image or an updated firmware image that corrects some functionality present in the current firmware image or add enhancements to the current firmware image. Next the processor authenticates the firmware update image and the source of the firmware update image to ensure that the updated firmware image is valid and that it is provided by a trusted source. In an exemplary embodiment, the electronic device includes a locked memory, for example, a flash memory or other non-volatile memory that maintains the device firmware. The instructions cause the processor to unlock the memory and initiate the firmware update image and firmware source authentication process. After the firmware update image and the source of the firmware update image have been authenticated, the instructions cause the processor to replace the current firmware image with the firmware update image, for example, by reflashing the non-volatile memory. After the updating is complete, the memory is locked; thereby, preventing unauthorized access to the updated firmware image.

An advantage provided by the present invention is that device security is maintained as the firmware is only replaced or updated when both the update firmware image and the source of the update firmware image are from authorized or trusted sources.

Another advantage provided by the present invention is that firmware updating efficiency is improved as a cold boot process does not have to be performed.

### BRIEF DESCRIPTION OF THE DRAWINGS

The present invention and the related advantages and features provided thereby will be best appreciated and understood upon review of the following detailed description of the invention, taken in conjunction with the following drawings, where like numerals represent like elements, in which:

FIG. 1 is a schematic block diagram of an exemplary electronic device implementing the secure flash update functionality according to the present invention;

FIG. 2 is a representation of the code configured to provide the secure flash update functionality when executed by the electronic device according to the present invention; and

FIGS. 3-5 are flow charts illustrating the operations performed by the electronic device when implementing the secure firmware update functionality according to the present invention.

### DETAILED DESCRIPTION OF THE INVENTION

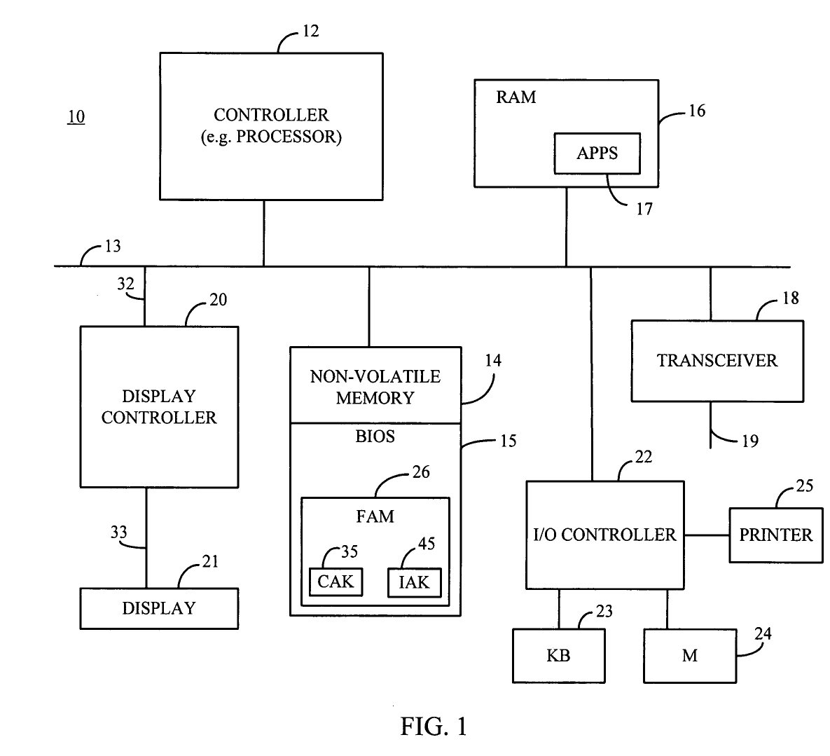

FIG. 1 is a schematic block diagram of an exemplary electronic device 10, for example, a desk top computer, a laptop computer, tablet PC, personal digital assistant (PDA), Internet appliance; embedded device, for example, routers and set top boxes, wireless communication devices, for example, cellular telephones or other suitable devices and combinations thereof incorporating the secure firmware update functionality according to the present invention. For purposes of illustration and not limitation, the electronic device 10 is represented as a laptop computer including at least one processor or other suitable controller 12, a first memory 14 (e.g. NVRAM, ROM, flash memory or other suitable non-volatile memory), a second memory 16 (e.g. RAM or other suitable volatile memory), a transceiver 18, a display controller 20 and an input/output (I/O) controller 22. The first memory 14, second memory 16, transceiver 18, display controller 20 and I/O controller 22 are all interconnected through and transfer data and instructions between the various other components (e.g. hardware subsystems) and the processor 12 through a bus 13.

The processor 12 may include an arithmetic logic unit (ALU) for performing computations, one or more registers for temporary storage of data and instructions, and a controller for controlling the operations of the laptop computer 10. In one embodiment, the processor 12 includes any one of the x86, Pentium™, and PentiumPro™ microprocessors manufactured by Intel Corporation, or the K-6 microprocessor marketed by Advanced Micro Devices. Further examples include the 6X86MX microprocessor marketed by Cyrix Corp., the 680X0 processor marketed by Motorola; or the Power PC™ processor marketed by International Business Machines. In addition, any of a variety of other processors, including those from Sun Microsystems, MIPS, NEC, Cyrix and others may be used for implementing the processor 12. The processor 12 is not limited to microprocessors, but may take on other forms such as microcontrollers, digital signal processors (DSP), dedicated hardware (e.g. ASIC), state machines or software executing on one or more processors distributed across a network.

The bus 13 may be implemented, for example, as one or more wires that contain and provide for the transfer of address, instruction and/or data information, a carrier wave including one or more modulated signals containing address, instruction and/or data information or any suitable medium or architecture for transferring signals or combinations thereof. For purposes of illustration and not limitation, the bus 13 may be implemented as a peripheral component interconnect (PCI) bus, a Universal Serial Bus (USB) interface or other suitable bus or communication architecture.

The first memory 14 may be implemented by a non-volatile memory, for example, a read only memory (ROM), flash memory, a plurality of memory devices, distributed memory such as servers on a network or other suitable devices capable of maintaining electrical signal therein. The first memory 14 includes portions thereof dedicated to the Basic Input/Output System (BIOS) code 15, which is used among other things to initialize and configure the hardware and other subsystems (e.g. display controller 20, I/O controller 22) of the laptop computer 10 during an initial power on or resume operation. Additionally, the BIOS code 15 includes instructions that when executed by the processor 12, cause the processor 12 to perform the secure firmware update functionality according to the present invention. The contents of the first memory 14 are maintained during power off or power down periods of the laptop computer 10.

In addition, the BIOS 15 may be stored in a processor readable medium or transmitted by a computer data signal embodied in a carrier wave over a transmission medium or other suitable communication link. The processor readable medium may include any medium that can store or transfer information, for example, an electronic circuit, a semiconductor memory device, a ROM, a flash memory, an erasable programmable ROM (EPROM), a floppy diskette, a CD-ROM, an optical disk, a fiber optic medium, a radio frequency (RF) link or other suitable medium. The computer data signal may include any signal that can propagate over a transmission medium, for example, electronic network channels, optical fibers, air, electromagnetic, RF links or other suitable transmission medium or combinations thereof. The code segments may be downloaded via computer networks, for example, the Internet, an intranet, LAN, WAN or other suitable network or combinations thereof.

The second memory 16 is a fast access memory, for example, a random access memory (RAM) that maintains application programs 17, for example, word processing, accounting, e-mail, MP3 programs, browsers and other suitable programs or combinations thereof that are transferred to the processor 12 for execution via bus 13. The RAM 16 contents are maintained when the laptop computer 10 is in either the full power (S0) or standby (S3) mode, but are not maintained during the power off or power down state. Although the second memory 16 is described as being a fast access volatile memory, those of ordinary skill in the art will recognize and appreciate that other memory configurations, for example, memory distributed over a network may be used in place of the RAM 16 and such alternate embodiments are contemplated by and fall within the spirit of the present invention and the scope of the present disclosure.

The transceiver 18 may include any suitable component, for example, an antenna, modem or wireless device capable of sending or receiving information, for example, a new or updated firmware image 19 to be applied to the laptop computer 10.

The display controller 20 receives image data 32 from the processor 12 or a corresponding image/graphics subsystem (not shown) and provides formatted data 33 for display on a corresponding display device 21, for example, a CRT, flat panel, computer monitor or other suitable device capable of presenting images and/or data. The formatted data 33 may also be maintained in the RAM 16 for subsequent display or manipulation.

The I/O controller 22 is configured to control the transfer of information between a plurality of input devices, for example, a keyboard 23, mouse 24, laser or light pointer, joystick or other peripheral input device and a plurality of output devices, for example, a printer 25.

In application, the present invention allows new or otherwise updated firmware image 19 to replace the current firmware (e.g. BIOS 15) image maintained in the non-volatile memory 14, only when the new or updated firmware image 19 is authorized and the source of the new or updated firmware image 19 is an authorized or trusted party. By providing this double layer of security, unauthorized access to the non-volatile memory 14 and the larger device to which the non-volatile memory 14 forms a part is substantially reduced or eliminated. When the laptop computer 10 is operating, the non-volatile memory 14 is in a locked state. Updating the non-volatile memory 14 only occurs in response to an S3 resume mode condition, when the laptop computer 10 is placed in the S3 state. The S3 state, referred to as standby, is an intermediate power-saving state in which some of the components of the laptop computer 10, for example, the processor 12 power down to conserve energy. The S0 state refers to the normal full power state of the laptop computer 10. When the laptop computer 10 is in the S3 state, the contents of the second or system (e.g. RAM) memory 16 is preserved in order to allow the laptop computer 10 to quickly enter into the S0 state.

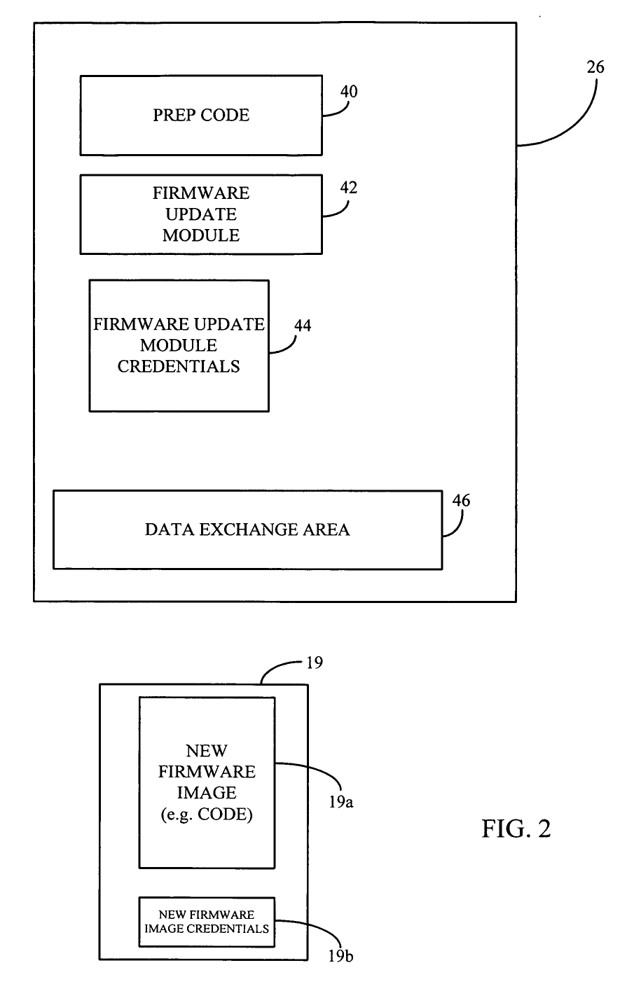

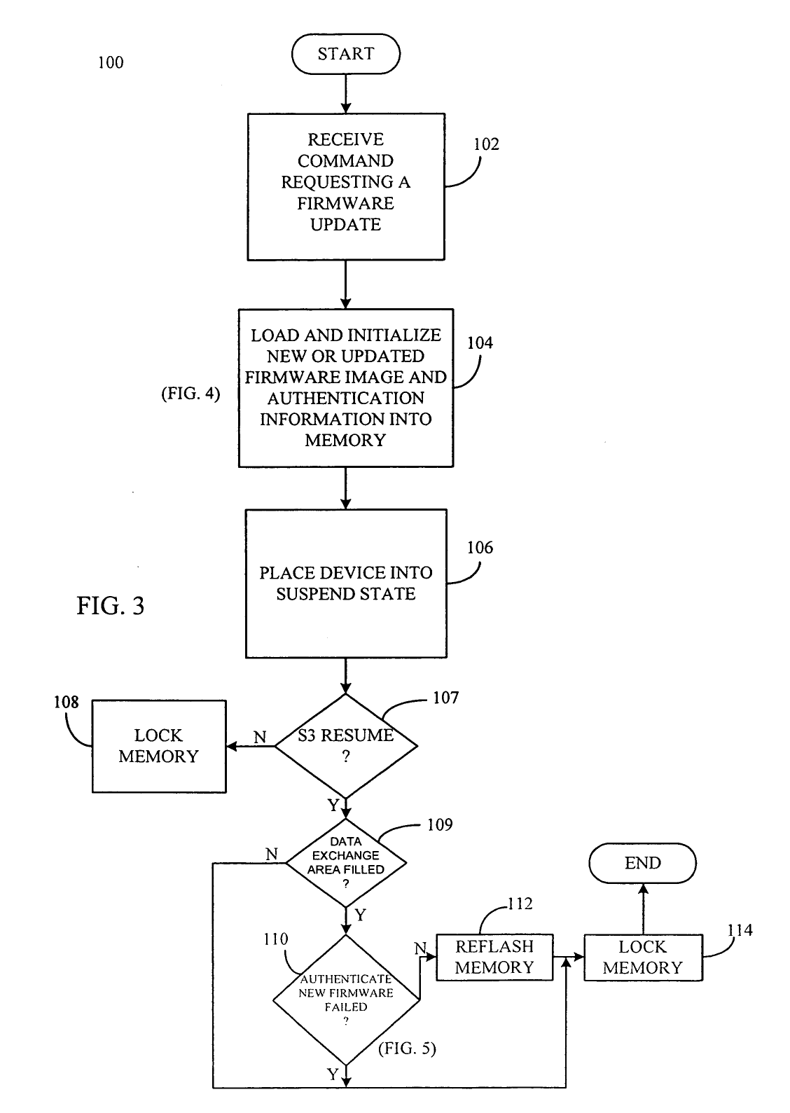

FIG. 2 is a representation of the Firmware Application Module (FAM) 26, which forms part of the BIOS 15 (FIG. 1) or firmware code and is configured to provide the secure flash update functionality according to the present invention. In operation, the processor 12 initiates and controls the updating of the non-volatile memory 14 by calling the FAM 16. The FAM 26 includes an authentication firmware update module (FUM) 42 that determines the authorization of the new firmware image 19 to be flashed into memory 14. In an exemplary embodiment, the authorization is determined, for example, by an RSA key pair (e.g. public key/private key) authentication technique. In application, an OEM generates an RSA key pair, then wraps the public component of the key pair within a binary module and includes the same as part of the newly generated firmware image, which is then hashed to create an unsigned public key container. The private key is then used to sign the public key container; thereby, creating a digitally signed container. This digital signature is what authorizes the new or update firmware image 19. If the public and private keys are a match, the new of updated firmware image 19 is authorized; otherwise, the firmware update image 19 is not authorized. If both the new firmware update image 19 and the source of the firmware update image 19 are not authorized, the update is denied and the non-volatile memory 14 remains locked. If both the new firmware update image 19 and the source of the firmware update are authorized, the non-volatile memory 14 is unlocked and then reflashed with the firmware update image 19 as discussed below with respect to FIGS. 3-5. The non-volatile memory 14 is then returned to its locked state.

The new or updated firmware image 19 includes, for example, the new firmware code 19a to be written to and maintained in the non-volatile memory of the laptop computer and new firmware image credentials 19b, used to authenticate the new firmware code 19a and aid in the execution of the flash (memory) update process. In an exemplary embodiment, the firmware image credentials 19b are maintained in a signed container that includes, for example, an SHA-1 hash of the new firmware code. The container is cryptographically signed with a secure private key, for example, using the RSA algorithm known to those of ordinary skill in the art The RSA algorithm specifies a public and private key which are respectively used for encrypting/signing and decrypting/verifying. Typically the RSA process is associated with a corresponding PKI. Thus, the present invention uses a cryptographically signed code module 19b embedded in the calling application to perform the flash update process. This provides an added level of security to the update process; thereby, substantially reducing or eliminating the ability to attack or otherwise prevent the memory update process.

FIG. 3 is a flow chart illustrating the operations performed by the laptop computer when implementing the secure firmware update method 100 according to the present invention. The following steps are performed by and/or in conjunction with the BIOS or core system software of the laptop computer. In step 102, the laptop computer receives a command requesting a firmware update. This may be accomplished, for example, by the user entering a command to update the system firmware, an internally generated signal or interrupt requesting an update or an update command signal being received from a remote location.

In step 104, the new or updated firmware image and authentication information (e.g. new firmware image credentials) are loaded into volatile memory and initialized. This may be accomplished, for example, by the laptop computer receiving the new or updated firmware image and new or updated firmware image credentials and placing the firmware image and credentials into the secure flash application directory.

In step 106, the laptop computer is placed in an S3 suspend state. This may be accomplished, for example, by explicitly searching and programming the ACPI registers in the DOS flash application or using the windows S3 API in the windows flash application. When the S3 state is entered, the non-volatile memory is unlocked and the new or updated firmware image is transferred to the laptop computer for subsequent reflashing of the non-volatile (e.g. flash) memory.

In step 107, a determination is made as to whether the S3 state should be resumed or continue. This may be accomplished, for example, by checking the status of a dedicated register or the BIOS ACPI POST code makes a determination of whether the resume is S3 or not by examining the ACPI tables. If the S3 state is not resumed, the method proceeds to step 108 where the non-volatile memory is locked. This may be accomplished, for example, by an elaborate PNPNVS module which implements the flash lock-down algorithm. The algorithm itself is flash part specific and provided by the vendor. If the S3 state is to be continued, the method proceeds to step 109.

In step 109, a determination is made as to whether the data exchange area of the FAM is filled. In application, the data exchange area is located in the SMM and is accessed by the SFLS API through the 32-bit SMI dispatcher. This may be accomplished, for example, by the FAM filling an argument packet with pointers to the firmware image and its credentials and the firmware update image and its credentials and invoking the Put function of the SFLS API. The BIOS in the S3 resume handler then invokes the Get function of the SFLS to check if the pointers are filled. If the data exchange area is not filled, the method proceeds to step 114, where the non-volatile memory is locked. Otherwise, the method proceeds to step 110.

In step 110, a determination is made as to whether the new firmware has been authenticated. This is accomplished, for example, by extracting the signature (e.g. new firmware update credentials) block and verifying (e.g. decrypting) the encrypted new firmware image credentials with the public key embedded within the BIOS and then re-hashing the firmware image and comparing with the stored hash in the container. If the new firmware update image has been authenticated, the method proceeds to step 112 where the memory is reflashed; thereby replacing the old firmware with the new authenticated firmware update image. Otherwise the method proceeds to step 114, where the non-volatile memory is locked.

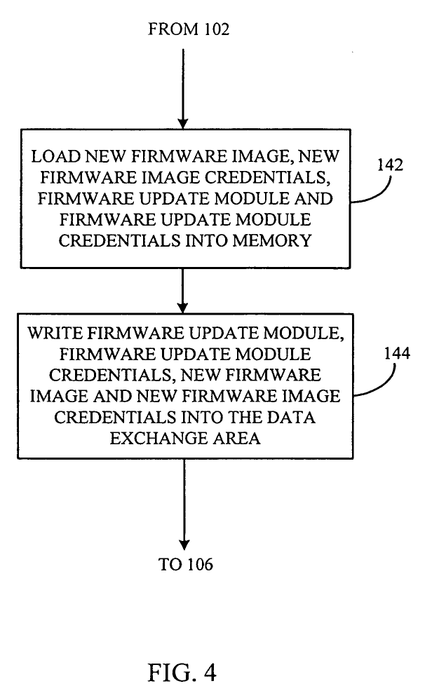

FIG. 4 is a flow chart illustrating the operations performed when the new firmware update image and new firmware authentication credentials are loaded and initialized. In step 142, the new firmware image, new firmware image credentials, the firmware update module and the firmware module update credentials are loaded into memory.

In step 144, the firmware update module, firmware update module credentials, new or updated firmware image and new or updated firmware image credentials are written into the data exchange area of the firmware application module. After the data exchange area has been populated, the process proceeds to step 106 (FIG. 3) where the laptop computer is placed into a suspend (e.g. S3 mode) state. By implementing the memory update during the S3 mode, the security and authentication of the update is assured, along with avoiding the latency that accompanies conventional cold boot processes.

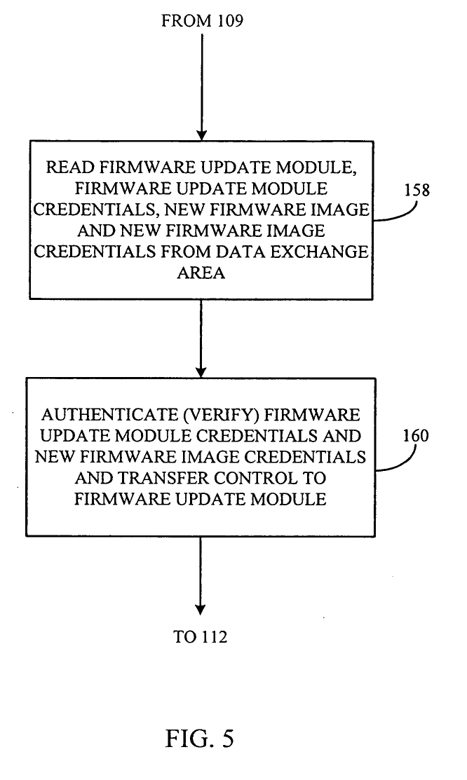

FIG. 5 is a flow chart illustrating the operations performed in determining whether the new or updated firmware authentication process has been successful. In step 158, the firmware update module, firmware update module credentials, new or updated firmware image and the new or updated firmware image credentials are read from the data exchange area of the firmware application module.

In step 160, the firmware update module credentials and new or updated firmware image credentials are authenticated. This is accomplished, for example, by extracting the firmware image credentials block or module and decrypting the credentials with the embedded public key. If decryption is successful, verification is successful or complete; otherwise, verification is not successful. After verification has been completed, control is transferred to the firmware update module which then starts the process of reflashing the non-volatile memory in step 112 (FIG. 3).

The foregoing detailed description of the invention has been provided for the purposes of illustration and description. Although an exemplary embodiment of the present invention has been described in detail herein with reference to the accompanying drawings, it is to be understood that the invention is not limited to the precise embodiment(s) disclosed, and that various changes and modifications to the invention are possible in light of the above teachings. Accordingly, the scope of the present invention is to be defined by the claims appended hereto.

What is claimed is:

1. A secure firmware update method, comprising:
receiving a firmware update image;
authenticating the firmware update image and the source of the firmware update image;
replacing the current firmware image with the firmware update image when both the firmware update image and the source of the firmware update image have been authenticated.

2. The secure firmware update method of claim 1, wherein replacing the current firmware image with the received firmware update image further includes reflashing the memory with the firmware update image.

3. The secure firmware update method of claim 1, wherein authenticating the firmware image and the source of the firmware update image further includes [Insert the verification process here].

4. The secure firmware update method of claim 1, further including placing a device in a suspend state before replacing the current firmware with the firmware update image.

5. The secure firmware update method of claim 4, wherein placing the device in the suspend state further includes placing the device in an S3 state.

6. The secure firmware update method of claim 2, further including unlocking the memory after the firmware update image and the source of the firmware update image have been authenticated.

7. An electronic device, comprising:
a processor; and
a memory, coupled to the processor, the memory maintaining instructions that when executed by the processor, cause the processor to:
receive a firmware update image,
authenticate the firmware update image and the source of the firmware update image, and
replace the current firmware image with the firmware update image when both the firmware update image and the source of the firmware update image have been authenticated.

8. The electronic device of claim 7, wherein the instructions cause the processor to reflash the memory with the firmware update image when both the firmware update image and the source of the firmware update image have been authenticated.

9. The electronic device of claim 7, wherein the instructions cause the processor to place the electronic device in a suspend state before replacing the current firmware image with the received firmware update image.

10. The electronic device of claim 7, wherein the instructions further cause the processor to unlock the memory after the firmware update image and the source of the firmware update image have been authenticated before the current firmware image is replaced.

11. The electronic device of claim 8, wherein the instructions further cause the processor to unlock the memory before the memory is reflashed with the firmware update image.

12. A method of securely updating the firmware of an electronic device, comprising:
receiving a request to update a current firmware image;
receiving a firmware update image;
placing the electronic device in a suspend operating state;
authenticating the firmware update image and the source of the firmware update image;
replacing the current firmware image with the firmware update image when both the firmware update image and the source of the firmware update image have been authenticated; and
returning the electronic device to a normal operating state.

13. The method of claim 12, wherein authenticating the firmware update image and the source of the firmware update image further includes verifying that the source of the firmware update image is a trusted source and that the firmware update image is a trusted image.

14. The method of claim 12, wherein replacing the current firmware image with the firmware update image further includes reflashing the memory with the firmware update image.
